(19) United States
(12) Patent Application Publication
(10) Pub. No.: US 2017/0130672 A1
(43) Pub. Date: May 11, 2017

(54) CHEVRON NOZZLE

(71) Applicant: RUDOLF GANZ, GUAYAS (EC)

(72) Inventor: RUDOLF GANZ, GUAYAS (EC)

(21) Appl. No.: 15/323,093

(22) PCT Filed: Jun. 26, 2015
(86) PCT No.: PCT/DE2015/000318

§ 371 Date: Dec. 29, 2016

(30) Foreign Application Priority Data
Jun. 30, 2014 (DE) 10 2014 009 784.6

(51) Int. Cl. F02K 1/48; F02C 3/04; F01D 25/16

(52) U.S. Cl. CPC F02K 1/48; F01D 25/16; F02C 3/04; F05D 2220/323; F05D 2240/50; F05D 2250/411

(57) ABSTRACT

A chevron nozzle (13, 14, 21, 22, 30) for an engine (10, 12) of an aircraft (11), having at least one nozzle ring (31) and chevrons (32) arranged on the nozzle ring (31). The aim of the invention is to further save fuel and further reduce sound emissions. For this purpose, the nozzle ring (31) together with the chevrons (32) is designed so as to be freely rotating with at least one rotational speed such that a position of the chevrons (32) can be continuously varied.

The invention relates to a chevron nozzle according to the preamble to claim 1.

Such chevron nozzles are used in aviation or in modern passenger aircraft, for example, the Dreamliner and the Boeing 787 or the Airbus A319.

Chevrons are sawtooth-shaped pattern at the exhaust nozzle of a jet engine. Chevron nozzles have virtually teeth and tooth gaps.

Chevrons have the advantage that they reduce noise emissions. However, chevrons can a minimum, however, undesirable thrust loss, for example, 0.25%, have the effect according to Wikipedia.

### STATE OF THE ART

A chevron nozzle is known from DE 12 69819441.

WO 2008 045 090 A1 discloses a chevrondiise, relative to each other in the two chevron nozzle elements are rotatable about a very limited angle in relation to each other to change a geometry and to achieve an adaptation to different flight conditions. A confirmation copy twistable, overlapping nozzle device changes the surface and geometry of the flow path during certain flight conditions.

These publications teach how a fuel saving can be achieved and indeed closely related to different flight conditions such as charge and start.

Another chevron nozzle is known from WO 2007 122 368 A1. This document describes such a nozzle in which the region of intervening gaps can be reduced. This nozzle should have improved performance and lower noise emissions. This is achieved by a certain adaptation of the tooth gaps. There can be large gaps and small gaps that are adjusted.

The document EP 2444645 A2 shows a recliner or control mechanism for a chevron nozzle.

### OBJECT OF THE INVENTION

The present invention has for its object to provide a chevron nozzle of the generic type, in which a further fuel savings and a further reduction of noise emissions can be achieved.

### SOLUTION AND ADVANTAGES OF THE INVENTION

The object of the present invention is achieved by a device having the features specified in the characterizing part of claim 1 in conjunction with the preamble thereof. The invention is based on the realization that vortices are thereby reduced by a constant rotation of chevron teeth in that the position of the teeth is constantly changing. Thus, the rotation of the invention reduces interference and turbulence in the outlet area of the nozzle. The reduction of such turbulence or interference vortex ensures fuel savings and an increase in thrust over known solutions.

The chevron nozzle invention with rotation is designed for gas turbines. The rotation can be free and thereby adapt to the vortices and/or aerodynamically directed and/or mechanically produce a specific rotation rate and/or direction. Special holes in the engine mount and/or the housing can be arranged so that the rotation operation. The idea in this nozzle is to form a tight helix between input and output flow. Thus, sound waves are captured and exhaust noise effectively damped. The rotation takes place in a reduction upstream directed disturbances, whereby turbulent flows are stabilized.

Another advantage of the rotation according to the invention is that the chevrons may be made smaller, which affects among other things, the engine output positive or a higher thrust possible.

By the helix formed by the rotation of the air stream (core stream and side stream) have more contact surfaces to the surrounding air mass, whereby a higher pushing force is possible.

Thus, such gas turbine engines with rotating nozzle for gas turbines are very beneficial.

A lower fuel consumption and lower sound emissions are important goals in commercial airliners and existing aircraft engines. Consequently, turbofan engines have become popular. But even in the military attempts to avoid noise or sound emissions have been made, so that the inventive concept can also be applied there. These goals have been achieved, although the introduction of chevron nozzles partially. This cold and hot air streams are mixed in principle. This principle has been taken in the inventive solution.

In the embodiment of the nozzle according to the invention, various patterns and shapes of the rear edges or teeth of this nozzle drive could be considered. For example, a radius at the tips of the teeth or the tooth spaces are optimized. Also, the height of the teeth can be adjusted. These geometric variations can be adapted to a rotational speed ceased. Also changes in tooth size according to the model of the prior art described are possible.

With a nozzle according to claim 1 both fuel economy and thrust increase or a reduction of noise emissions can be achieved.

### ADVANTAGEOUS EMBODIMENTS OF THE INVENTION AND FURTHER ADVANTAGES

Further advantageous embodiments of the invention are characterized in the dependent claims set forth hereinbelow.

In an advantageous development of the inventive nozzle there is provided that the nozzle ring is provided with a bearing which is fixed to an engine part, in particular an engine cowling, an engine housing and/or a core shell portion. The bearing mounting allows free rotation of the chevron rings. The rotation may be linksherung or clockwise.

Preferably, the bearing is a plain bearing such as a hydrodynamic bearing, a roller bearing or a magnetic bearing. The bearings can be relatively easily carried out, which has a favorable action on the moment of inertia and the engine mount. The roller bearing is relatively low-maintenance. A magnetic bearing has virtually no friction, so fuel can be saved. Conceivable are also other camps, such as ball bearings, and the like.

In order to control the rotational speed of the chevron rings, it is expedient that the nozzle ring is driven by a motor with a drive. The drive can be an electric motor and is therefore easily controlled or regulated so that there is always an optimal rotational speed, and depending on flight operations is adjustable. A controlled rotation may thus be achieved by the use of motors.

Alternatively, the nozzle ring can have free rein, the rotation by at least one drive element, in particular by fins, carried out that are aerodynamically driven by the engine flame. Advantageously, the nozzle ring is independent of an additional motor drive. In this mode, the free rotation of the chevron rings in direction and/or rotational speed can adapt to Austrittssströmung. It can also be aerodynamically affected to rotate in a specific direction and/or rate.

The chevrons may be square at the tips and/or the indentations or rounded. In a further advantageous embodiment of the invention, the chevrons instruct the chevron tips and/or to the chevron recesses, preferably in both places, a radius of at least 2 cm in particular. This reduces noise emissions.

The engine is preferably provided with an air inlet, a fan, a compressor, a combustor, a turbine, an exhaust nozzle and a housing. However, other engine versions, such as turboprop engines are also conceivable.

A particularly preferred embodiment of the invention is characterized in that the engine is provided with an engine mount, and the engine mount has at least one recess or an opening for at least one nozzle ring. In the recess or opening the nozzle ring can rotate freely. The engine housing and/or the engine cowling at the end of the nozzle is well fastened to a wing, so that a stable suspension is possible.

Because it must be especially in wide-bodied aircraft on low noise emissions, it is advantageous if the nozzle of the invention is used in a turbofan engine, the nozzle for a nuclear power and/or a by-pass is used.

Because also in the military field is desired to reduce noise emissions, it is advantageous if the nozzle of the invention is used in a jet engine.

### BRIEF DESCRIPTION OF THE DRAWINGS

Embodiments are described with reference to the drawings, wherein further advantageous developments of the invention and advantages thereof are disclosed.

Shown are:

FIG. 1 is a perspective view of a turbofan engine with two nozzles according to the invention, wherein the engine is disposed on an aircraft by an engine mount structure and provided with a housing, and a first chevron rotary nozzle for a nuclear power and a second nozzle is provided for a bypass.

FIG. 2 is a perspective view of a jet engine with a chevron-atomiser according to the invention.

FIG. 3 a perspective view of the nozzle ring chevron rotation nozzle, as shown in FIG. 1 or FIG. 2 for use in engines with gas turbines.

FIG. 4 is a schematic representation of an engine with the chevron nozzle invention.

### DETAILED DESCRIPTION OF THE INVENTION

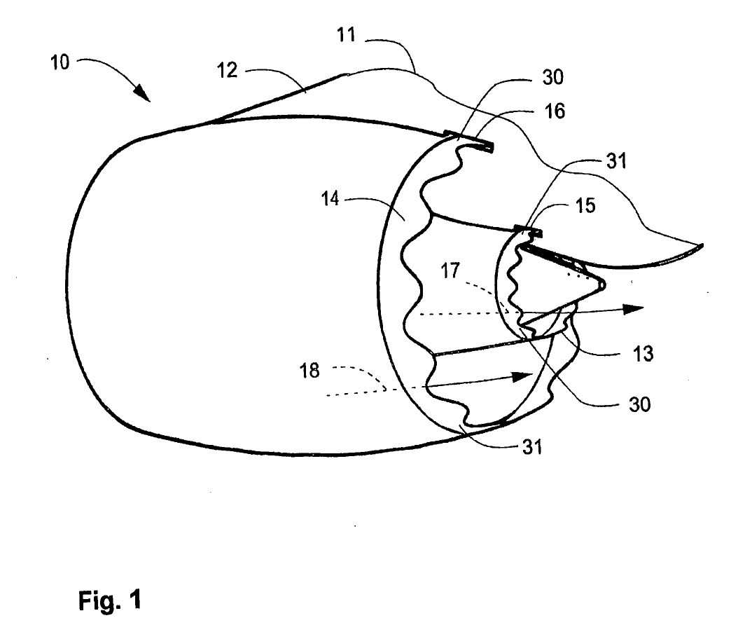

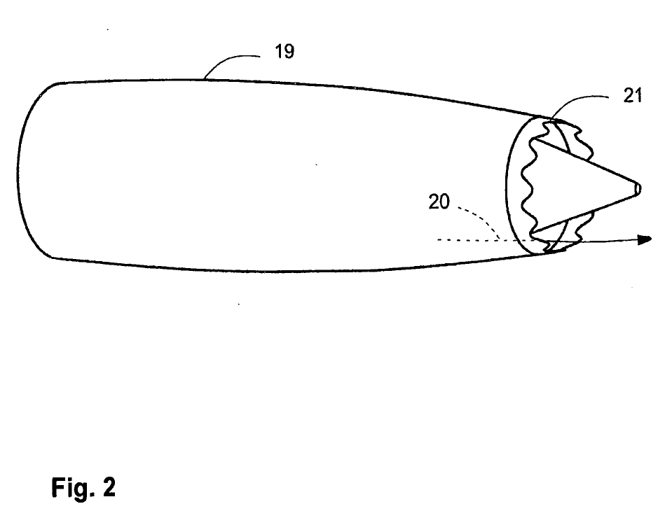

FIGS. 1 to 4 illustrate a chevron rotary nozzle 20 for an engine 10 (FIG. 1) or 19 (FIG. 2) of an aircraft 11 (FIG. 1) comprising at least one nozzle ring 25 and arranged on the nozzle ring 25 chevrons 26. The aircraft 11 is shown only symbolically.

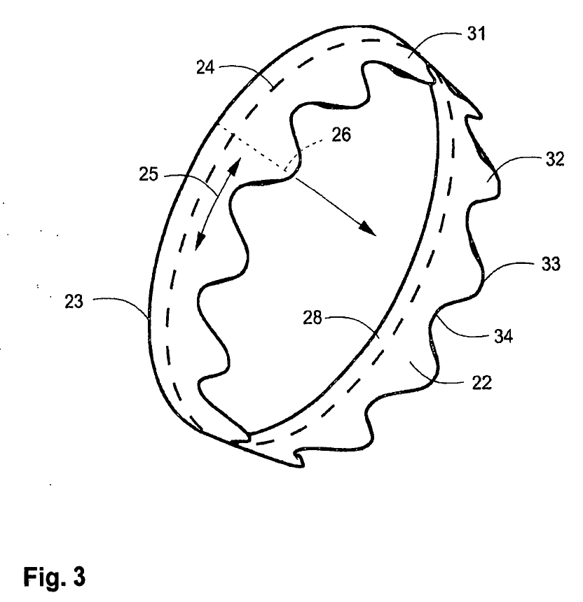

The nozzle ring 25 is made is freely rotatable together with the chevrons 26 (FIG. 3) having at least a rotational speed, so that a position of the chevrons 26 is continuously variable.

FIG. 1 illustrates a use of chevron nozzle in an engine 10 with an engine mount 12, wherein the engine mount has at least one recess or an opening 15, 16 for at least one nozzle ring 25.

More specifically, two chevron nozzles 13, 14 in a turbofan engine 10 are provided, wherein the first nozzle 13 is used for a core stream, and the second nozzle 14 for a turbofan.

By engine mount 12, the engine 10 is mounted in a known manner on a wing of the aircraft 11 and mounted.

The engine 10 thus comprises a core current chevron nozzle 13 and a turbofan chevron atomiser 14.

By known mounting means, rotation of the nuclear power-chevron rotary nozzle 13 and the turbofan-chevron-rotating nozzle 14 would be impossible.

Therefore, the engine mounting for the nozzles 13, 14 according to the invention comprises 12, the openings 15, 16, extending through the nozzle ring 25, so that free rotation is possible.

Another advantage of the invention with turbofan engines 10 is that interactions between the core stream 17 and stream 18 can be effectively reduced by the rotation of the invention. An improved performance and low noise level is the result.

FIG. 2 shows a chevron nozzle 20 in a jet engine 19 with a nuclear power 17 has The engine 19 is a single chevron atomiser 20.

FIG. 3 shows that the chevrons 26 wherein the chevron tips 27 and the chevron recesses 28, ie 2 cm to 20 cm is present in both places in each case rounded, and in each case about a radius of more than 2 cm, for example.

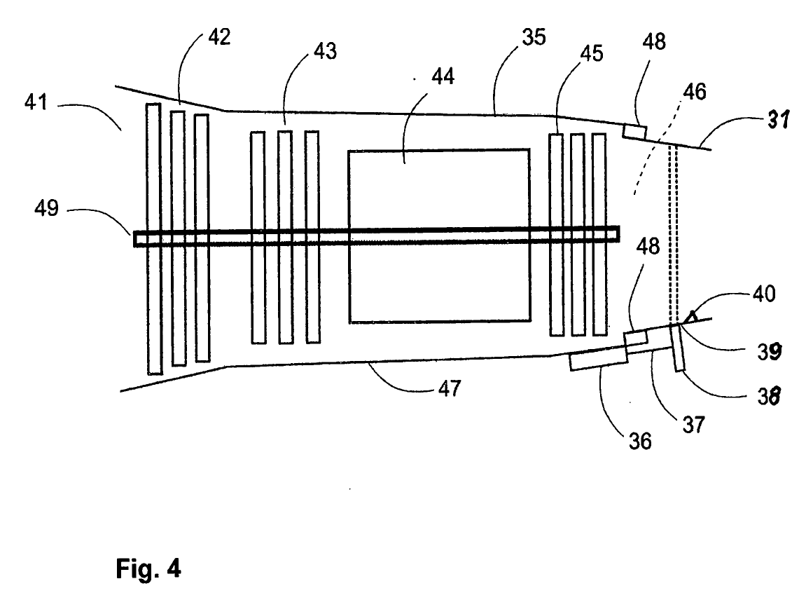

FIG. 4 shows that the nozzle ring 25 is provided with a bearing 42 which is fixed to an engine part 29, such as a cowl, an engine housing or a sheath-core part.

As further illustrated FIG. 4, the nozzle ring 25 is connected to an electric motor drive 30 so that the nozzle ring 25 is driven by a motor with the drive.

This may be 32 fixedly connected to a shaft 31 of the drive a first drive member.

This element 32 drives a second drive element 33, which is firmly connected to the nozzle ring 25.

Both elements 32, 33 may be gears and form a gear.

The wheel 33 is located outside of the ring 25 and has about the same diameter as the ring 25.

Alternatively, the nozzle ring can have free rein to be run without a drive motor. The rotation of the ring 25 is carried out by a non-motorized drive element, for example, by slanted slats 34.

The slats 34 may act as propellers and are aerodynamically driven by the exhaust plume.

With the free mode, the rotation of the nozzle in the direction 23 (FIG. 3) and/or the rotational speed of flow 24 (FIG. 3) will adjust. The rotation can also be aerodynamically affected to rotate in a specific direction 23 and/or rate.

A more controlled rotation (direction 23) may be achieved by the use of motors 30 (FIG. 4).

Freely rotatable means that the ring 25 can rotate more than 360 degrees. When the ring 25 only to a limited angle could turn, that would be no free rotation. Free running means that no electric motor or the like is used in order to achieve the rotation of the ring 25.

The engine (FIG. 4) has an air inlet 35, a so-called fan 36, a compressor 37, a combustor 38, a turbine 39, the exhaust nozzle 40, a shaft 43 and a housing 41, at which the drive 30 may be attached.

FIGS. 3 and 4 thus show that 22 can be used in conjunction with the chevron nozzle 25 and exhaust nozzle 40 of the connections 21 and storage systems.

The invention is not limited to these examples, as well as other engines like turboprop or turbofan engines other can be used.

Also, each described or shown example feature can be combined with one shown or described feature an another example.

Thus, characteristics of the engine of FIG. 1 incorporating features of the engine according to FIG. 4 with each other are combined. For example, a drive used 30 of FIG. 4 for both nozzles 13, 14. Also, a nozzle 13 can have a free run and the other nozzle 14 have a motor drive and vice versa.

### LIST OF REFERENCE NUMBERS

10 turbofan engine
11 aircraft
12 engine mounting
13 nuclear power chevron atomiser
14 turbofan chevron atomiser
15 first opening
16 second opening
17 Kemstrom
18 sidestream
19 jet engine
20 nuclear power
19 Motor
21 Chevron-atomiser
22 chevron-atomiser
23 connections
24 storage systems
25 direction
26 flow
27—
28—
29—
30 chevron nozzle
31 nozzle ring
32 chevrons
33 chevron tips
34 chevron recesses
35 engine part
36 electric motor drive
37 wave
38 first drive element
39 second drive element
40 slats
41 air inlet
42 fan
43 compressor
44 combustor
45 turbine
46 exhaust nozzle
47 housing
48 available
49 wave

1. Chevron nozzle (13, 14, 21, 22, 30) for an engine (10, 12) of an aircraft (11) comprising at least one nozzle ring (31) and on the nozzle ring (31) arranged chevrons (32), characterized in that the nozzle ring (31) is carried freely rotatable along with the chevrons (32) having at least a rotational speed, so that a position of the chevrons (32) constantly is changed.

2. Chevron nozzle according to claim 1, characterized in that the nozzle ring (31) with a bearing (48) is provided, which is attached to an engine part 35, in particular a cowl, an engine case (47) and/or a core shell part.

3. Chevron nozzle according to claim 2, characterized in that the bearing (48) is a sliding bearing, a rolling bearing or a magnetic bearing.

4. Chevron nozzle according to claim 1, characterized in that the nozzle ring (31) with a drive (36) is motor-driven.

5. Chevron nozzle according to claim 1, characterized in that the nozzle ring (31) has a free running, the rotation by an at least one drive element, in particular by fins (40) takes place, which are aerodynamically driven by an engine beam.

6. Chevron nozzle according to claim 1, characterized in that the chevrons (32) having at chevron tips (33) and/or on chevron recesses 34, preferably at both positions, a radius of preferably at least 2 cm.

7. Use of a chevron nozzle according to claim 1 in an engine (10, 19) having an air inlet (41), a fan (42), a compressor (43), a combustion chamber (44), a turbine (45), a thrust nozzle (46) and/or a housing (47).

8. Use of a chevron nozzle according to in an engine (10, 19) with an engine mount (12), wherein the engine mount (12) has at least one recess or an opening (15, 16) for at least one nozzle ring (31).

9. Use of a chevron nozzle according to claim 1 in a turbofan engine (10), said nozzle (30) for a core stream (13) and/or a by-pass (14) is used.

10. Use of a chevron nozzle according to claim 1 in a jet engine (19).

11. Chevron nozzle according to claim 2, characterized in that the nozzle ring (31) with a drive (36) is motor-driven.

12. Chevron nozzle according to claim 2, characterized in that the nozzle ring (31) has a free running, the rotation by an at least one drive element, in particular by fins (40) takes place, which are aerodynamically driven by an engine beam.

13. Chevron nozzle according to claim 2, characterized in that the chevrons (32) having at chevron tips (33) and/or on chevron recesses 34, preferably at both positions, a radius of preferably at least 2 cm.

14. Chevron nozzle according to claim 3, characterized in that the nozzle ring (31) with a drive (36) is motor-driven.

15. Chevron nozzle according to claim 3, characterized in that the nozzle ring (31) has a free running, the rotation by an at least one drive element, in particular by fins (40) takes place, which are aerodynamically driven by an engine beam.

16. Chevron nozzle according to claim 3, characterized in that the chevrons (32) having at chevron tips (33) and/or on chevron recesses 34, preferably at both positions, a radius of preferably at least 2 cm.

17. Chevron nozzle according to claim 4, characterized in that the chevrons (32) having at chevron tips (33) and/or on chevron recesses 34, preferably at both positions, a radius of preferably at least 2 cm.

18. Chevron nozzle according to claim 5, characterized in that the chevrons (32) having at chevron tips (33) and/or on chevron recesses 34, preferably at both positions, a radius of preferably at least 2 cm.
